(19) United States
(12) Patent Application Publication
(10) Pub. No.: US 2013/0318635 A1
(43) Pub. Date: Nov. 28, 2013

(54) COPYRIGHT SECURITY FOR ELECTRONIC BOOKS

(71) Applicant: Cory Verner, San Marcos, CA (US)

(72) Inventor: Cory Verner, San Marcos, CA (US)

(73) Assignee: eCHRTISTIAN, INC., Escondido, CA (US)

(21) Appl. No.: 13/480,474

(22) Filed: May 25, 2012

(51) Int. Cl. G06F 21/24; H04L 9/00

(52) U.S. Cl. 726/32; 713/189

(57) ABSTRACT

A computerized method for deterring unauthorized distribution of an electronic book comprising the steps of receiving a request to purchase the electronic book, receiving a set of personal identifiers from a user, receiving a set of publisher identifiers from a publisher of the electronic book, embedding both sets of identifiers into the electronic book, and displaying the electronic book with the embedded identifiers.

### FIELD OF THE INVENTION

The present invention relates generally to deterring unauthorized distribution of copyrighted information and more specifically protecting electronic book content.

### BACKGROUND

With explosive growth in the electronic book market, publishers are looking for ways to effectively distribute electronic books (hereinafter referred to as ebooks), while preventing those ebooks from being resold or used in violation of terms of use. The current ebook reader software is intended to control the ebook by preventing redistribution of the digital file, but this does not satisfy ebook users' needs because this places unnecessary restrictions like limiting the ebook installation onto one device. Users want ebooks free of constraints so they can read the book on their desktop computer, laptop computer, or other mobile device. To make matters worse, users can easily be crack the digital rights management (hereinafter referred to as DRM) of the ebook reader software currently being used. DRM does not stop those individuals intent on misconduct and, hence, honorable consumers are penalized by enduring complicated DRM solutions. Some in the industry are calling for ebooks to be distributed without DRM, but others are concerned that the removal of DRM will lead to ebook anarchy. The present disclosure details system(s) and method(s) that allow ebooks to be sold as portable documents that can be used on any device without a complicated technical restriction.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of various exemplary embodiments, a computerized method for deterring unauthorized distribution of an electronic book is provided, the method comprising: electronically receiving a request to purchase the electronic book; electronically receiving a set of personal identifiers from a user; electronically receiving a set of publisher identifiers from a publisher of the electronic book; electronically embedding at least one identifier of the set of personal identifiers and at least one identifier of the set of publisher identifiers into the electronic book; electronically storing the electronic book with the set of personal identifiers and the set of publisher identifiers to a computer memory, wherein the computer memory contains information of a unique transaction between the user and a seller; electronically transmitting the electronic book to a user device; and displaying the at least one embedded identifier when content of the electronic book is displayed on the user device, wherein the at least one embedded identifier is located on at least one page of the electronic book.

In another aspect of various exemplary embodiments, a watermark embedding system for an electronic book is provided, the system comprising: a computerized watermark embedding engine; a computerized watermark generator in the computerized watermark embedding engine, the computerized watermark generator operating to produce a watermark for the electronic book, wherein the watermark includes at least one personal identity information about a first user of the electronic book and at least one publisher information about the electronic book; a computerized watermark integrating engine in the computerized watermark embedding engine, the computerized watermark integrating engine operating to combine the personal identity information and the publisher information into a single watermark; and a computerized watermark decision engine in the computerized watermark embedding engine, the computerized watermark decision engine operating to insert the watermark into the electronic book, wherein if the electronic book contains more than one page, then the watermark decision engine decides which pages to receive the watermark, wherein the watermark decision engine is further configured to decide a location on the page in which to place the watermark.

In yet another aspect of various exemplary embodiments, an unauthorized copying-deterrent system for an electronic book is provided, the system comprising: a web-based system; a copying-deterrent module in the web-based system, the module having a plurality of computer readable instructions that implements a copying-deterrent method; a module having a plurality of computer readable instructions that operate to receive a request from a first user to purchase the electronic book via the web-based system; a module having a plurality of computer readable instructions that operate to receive a set of personal identifiers from the first user; a module having a plurality of computer readable instructions that operate to receive a set of publisher identifiers from a publisher of the electronic book; a module having a plurality of computer readable instructions that operate to embed the set of personal identifiers and the set of publisher identifiers into the electronic book; a module having a plurality of computer readable instructions that operate to store the electronic book with the set of personal identifiers and the set of publisher identifiers to a computer memory, wherein the computer memory contains information of the first user and the publisher; a module having a plurality of computer readable instructions that operate to transmit the electronic book to a first user device; and a module having a plurality of computer readable instructions that operate to display the set of personal identifiers and the set of publisher identifiers when the electronic book is displayed on the first user device, wherein the set of personal identifiers and the set of publisher identifiers are located on at least one page of the electronic book.

### BRIEF DESCRIPTION OF THE DRAWINGS

FIG. 1 is a graphic representation of the general process for embedding a watermark into an electronic book.

FIG. 2 is a block diagram of an exemplary embodiment network environment implementing FIG. 4.

FIG. 3 is a flow chart of an exemplary embodiment process of embedding personal and publisher identifiers in the exemplary embodiments of FIG. 1 and FIG. 2.

FIG. 4 is a block diagram of an exemplary embodiment seller server embedding engine.

FIG. 5 is a block diagram of an exemplary embodiment user device.

FIG. 6 is a graphic representation of an exemplary embodiment watermark.

FIG. 7 is a graphic representation of an exemplary embodiment watermark displayed on a user device.

FIG. 8 is a graphic representation of another exemplary embodiment watermark.

FIG. 9 is a graphic representation of still another exemplary embodiment watermark.

### DETAILED DESCRIPTION

From the very inception of digital media, rights holders have attempted to protect their works with DRM. Typically, DRM is software or other technological method used to control access to a work. In the non-ebook space, DRM might use a username or password, or software that prevents a digital file from being copied. DRM often includes copyright management information (hereinafter referred to as CMI) and other traceable information, such as unique serial numbers. The goal of DRM is to prevent the original purchaser or first user from redistributing the work without authorization. First efforts at DRM only prohibited the user from copying digital works, but DRM now can control viewing, copying, printing, and altering of any kind of content. This is made possible through software which allows a copyright holder to set restrictions on content by defining a user and usage rights through data encryption. Before ebook DRM, the copyright holder could develop an enforcement model that verifies user identification and then track the use of that content so that a buyer can only use the content in the way the copyright holder intended when the DRM was originally assigned. An everyday example of DRM is a software CD or a DVD movie. DRM makes it difficult to copy this information to another storage media.

A significant move toward providing protection for copyright holders came with the Digital Millennium Copyright Act (hereinafter referred to as DMCA). Prior to the DMCA, Congress was devoting significant attention to the problems faced by copyright enforcement in the digital age. This legislative effort resulted in the DMCA, signed into law Oct. 28, 1998. The DMCA provided a variety of protections for digital works, such as Section 1201, which prohibits the “circumvention” of “a technological measure that effectively controls access to a work protected under this title.” In other words, the statute requires something technical that controls access. In the most rudimentary sense, a software application that requires a username and/or password would probably be a “technological measure” and “effectively control access.”

The DMCA also prohibits the removal of copyright management information (hereinafter referred to as CMI). CMI includes (1) the title and other information identifying the work, including the information set forth on a notice of copyright, (2) the name of, and other identifying information about, the author of a work, (3) the name of, and other identifying information about, the copyright owner of the work, including the information set forth in a notice of copyright, (4) the name of, and other identifying information about, a performer whose performance is fixed in a work other than an audiovisual work, (5) the name of, and other identifying information about, a writer, (6) terms and conditions for use of the work, (7) identifying numbers or symbols referring to such information or links to such information, and (8) such other information as the Register of Copyrights may prescribe by regulation, except that the Register of Copyrights may not require the provision of any information concerning the user of a copyrighted work. However, CMI does not include any personally identifying information about a user of a work or of a copy of a work.

Removal of CMI is a violation of the DMCA, but removal of CMI is not “circumvention,” as that term is used in 1201. It is a separate violation of Section 1202's prohibition on removing CMI. Section 1202 is intended to prevent the wide distribution of copyrighted works that fail to include attribution, as well as terms and conditions of use and tracking data such as serial numbers that enable rights holders to track and enforce their rights against piracy and mass distribution by counterfeiters. Under this section, the DMCA prohibits removal of the CMI by any person without authorization. Thus, a publisher can enforce the copyrights that it owns against a third-party with whom the publisher has no privity of contract.

Today, DRM is used to prevent use of a Kindle® ebook on other devices and to prevent iPhone® or iPad® ebooks from being used on or transferred between other devices. However, users want ebooks with the mobility to unrestrictedly transfer an ebook from their personal computer to any of their mobile computing devices. Accordingly, there is a need to provide the copyright owner with a means to prevent ebook copying yet allows an individual user to unrestrictedly transfer the ebook between multiple devices.

In one exemplary embodiment, a publisher watermarks the pages of an ebook with the personal information of the user who purchases the book. This watermark would be visible and may be placed so that it is difficult to remove, such as randomly embedding the watermark throughout the ebook. By embedding a user's identifying information, non-limiting examples, such as name, email and telephone number directly on the pages of the ebook within the watermark, the user would be deterred from reselling the book for fear of 1) disclosing his personal information and 2) violating DMCA Section 1201. Hence, this type of watermark would be a technological measure that would control access to the ebook by discouraging the user from copying.

In another exemplary embodiment, a publisher watermarks the pages of an ebook with the personal information of book's first user of the book. As before, the watermark would be visible and may be placed so that it is difficult to remove. This embodiment allows a first person to purchase an ebook and transfer by gift to a second person. In this example, the second person becomes the first user. Thus, the watermark does not contain information on the purchaser of the ebook, rather, it contains information on the first user of the ebook.

In yet another exemplary embodiment, a publisher watermarks the pages of an ebook with an invisible mark, only to become visible when transmitted to another device. This other device could be the same user or a different user. In essence, the user is not deprived of a watermark-free ebook experience, similar to what the user would experience when purchasing a printed copy of a book. For the same reasons above, this type of watermark would be a technological measure that would control access to the ebook.

In still another exemplary embodiment, a publisher watermarks the pages of an ebook with the personal information of the ebook's first user and the publisher's information. The watermark may be visible or invisible and may be placed so that is difficult to remove. The publisher's information, the serial number for example, could be embedded with the user's identifying information in such a way that would render removal of any portion of the watermark a violation of DMCA 1201 and 1202.

In another exemplary embodiment, the user's identifying information may be placed within the contents of the computer files that comprise an ebook, commonly referred to as electronic publication (EPUB) files. Within the EPUB files, there generally exists the following computer file folders: Text (html files with the book's text), Styles (stylesheets for how to display that html), Images (the images shown throughout the book, including cover image), Fonts (any special fonts used within the title), Misc (general repository for other ebook information), toc.ncx/content.opf files (table of contents files). In one example, a text file with the file extension “.TXT”, or other similar variant, containing the user's information may be placed within the Text folder, though this particular implementation would not be preferable because circumvention by deletion of the file is rather simple and does not significantly discourage users from copying the ebook. In another example, an image file with the file extension “.JPG”, or other similar variant, of the watermark could be placed in the Images folder. Again, however, this particular implementation would not be preferable because circumvention by deletion is rather simple. Thus, the precise method of implementation must remain a trade secret because discouraging unauthorized distribution of an ebook depends on the level of difficulty of removing the user's identifying information. One skilled in the art could devise numerous methods to insert the user's identifying information within the EPUB folders, and may employ one method or a combination of methods.

In the following detailed descriptions of various exemplary embodiments, reference is made to the accompanying drawings that form a part hereof, and in which is shown, by way of illustration, specific embodiments that may be practiced. It is to be understood that other embodiments may be utilized and structural changes may be made without departing from the scope of the present disclosure.

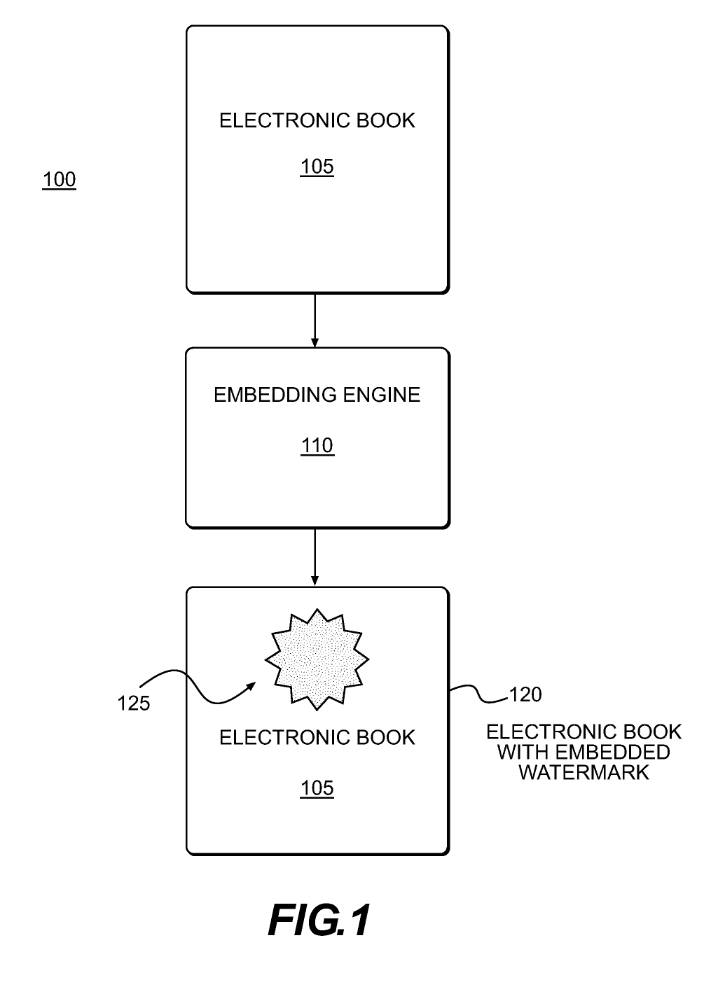

Turning now to FIG. 1, a graphic representation of the general process 100 for embedding a watermark 125 into an ebook 105 is shown. An exemplary embodiment computerized watermark embedding engine 110 receives an ebook 105, and adds legible information, perceivable by a human viewer, to create a form of security for an ebook 120. This form of security, a watermark 125, may be irreversible once it is added. The watermark 125 may contain personal identity information of the first user of the ebook 105 thereby deterring the first user from unauthorized distribution of the book to second users. Personal identity information may include, but is not limited to, a name, an email address, an IP address, a phone number, a social security number and so on.

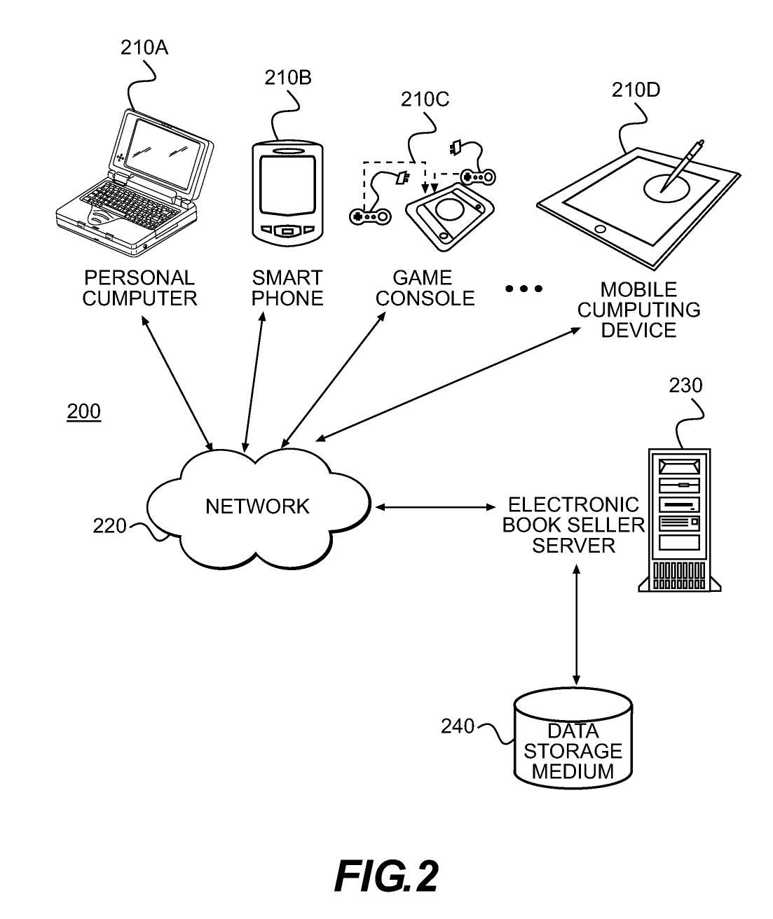

FIG. 2 is an exemplary embodiment network environment 200 with attendant hardware such as Internet, servers and associated processors, memory, etc. The network environment 200 may interact with the system 100 through one or more user devices 210A-N. User devices 210A-N may include, but are not limited to, a personal computer 210A, a mobile phone 210B, a game console 210C, or other mobile computing device 210N. Each of these devices 210A-N may access a seller's ebook server 230 through a network 220, such as the Internet, but may include other networks such as wide area networks (WAN), local area networks (LAN), or any other network allowing inter-computer data communication, particularly with the seller's ebook server 230. Data communication with the seller's ebook server 230 or user devices 210A-N may occur real-time or be established through a periodic connection with the network 220. The seller's ebook server 230 may be managed by an administrator and may be in communication with a non-transitory computer readable storage medium 240. The non-transitory computer readable storage medium 240 may be operative to store user profiles with personal identifying information such as a name, email address, residence address or other billing information, log in name, and password. The non-transitory computer readable storage medium 240 may also be operative to store transaction information, such as purchase price, type of ebook, serial number of the ebook, or any other information that may be useful to the seller or publisher. In addition, the non-transitory computer readable storage medium 240 may also be operative to store publisher information, such as publisher name, author name, title of ebook, copyright date, or any other information that may be useful to the seller or publisher.

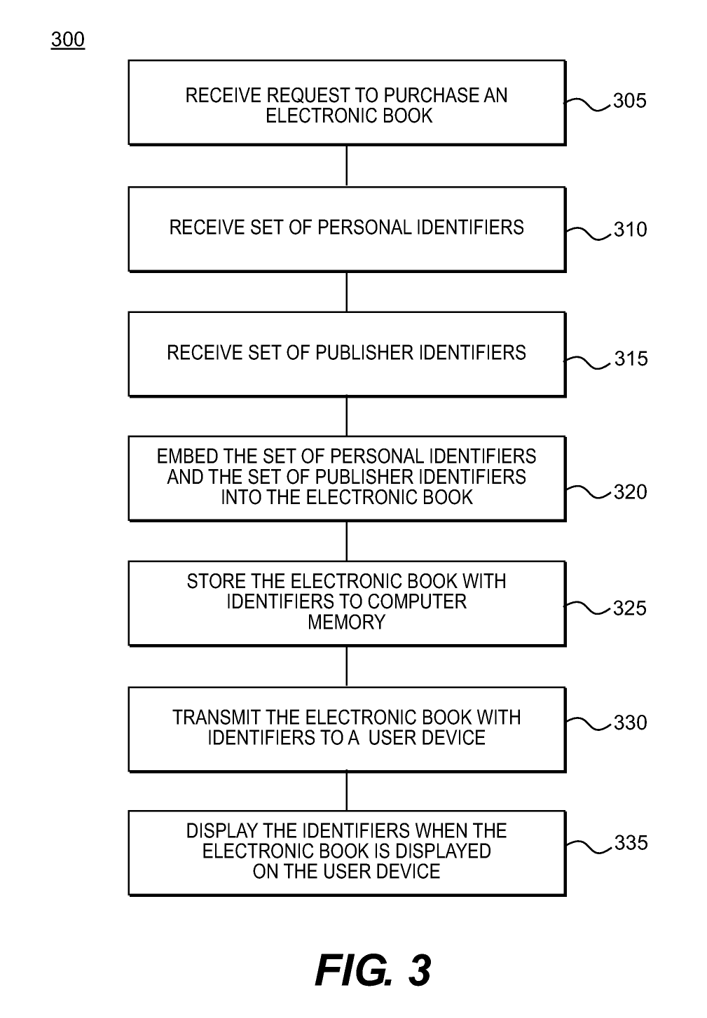

FIG. 3 extends on FIGS. 1-2 and shows an exemplary method 300 of deterring unauthorized distribution of ebooks through the use of the computerized watermark embedding engine 110. In the flow chart, the operations are summarized in individual blocks. The operations of the exemplary method 300 may be performed by computer readable instructions, such as software, that can be executed by one or more processors or a device 210A-N, such as a device that includes the exemplary computerized watermark embedding engine 110. The exemplary method 300, however, describes a process where the computer readable instructions are executed by the seller server 230.

First, a request to purchase an ebook by the seller is received (step 305). The request may be made to the seller server 230 through the exemplary network environment 200, other network environment, or via an administrator, such as through a telephone call. Next, a set of personal identifiers is received (step 310). The seller server 230 may require login with a user name and password in order to receive the personal identifiers. Alternatively, the personal identifiers may be provided during a single transaction without log in. Then, the seller server 230 receives a set of publisher identifiers either from the publisher at the time of the transaction between the seller and the user or via the non-transitory computer readable storage media (step 315). Publisher identifiers are defined in DMCA Section 1201, and may include, but are not limited to the publisher name, the ebook author, the year in which the ebook was copyrighted, the ebook title, and the ebook serial number. Next, the acquired personal identifiers and publisher identifiers are electronically embedded into the ebook (step 320) and stored to non-transitory computer readable storage media (step 325). The stored information may include a single, inseparable data cache that includes the ebook, the personal identifiers, and the publisher identifiers. Finally, the data cache is transmitted to a user device 210A-N via the exemplary network 220 (step 330) whereby the ebook may be displayed with the personal identifiers and publisher identifiers on a user device 210A-N (step 335).

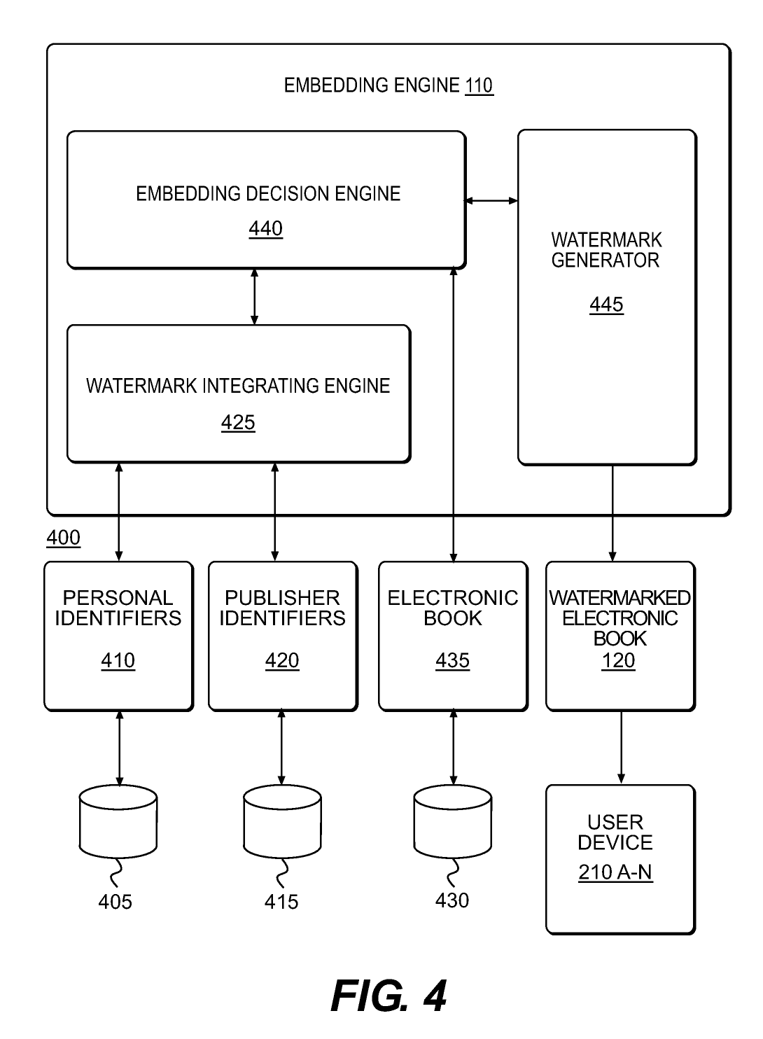

FIG. 4 shows an exemplary embodiment seller server embedding engine 400. Details of various modules that may operate in conjunction with the computerized watermark embedding engine 110 can now be seen. The computerized watermark embedding engine 110 can be a software or hardware system with computer readable instructions to gather personal identity information and publisher information that is then embedded into a human-readable watermark 125 located on a page or pages of an electronic book. The computerized watermark embedding engine 110 is part of a system comprising various modules designed to execute particular tasks in series or parallel. The system may be web-based, application based, and so forth.

The following is a detailed explanation of the various modules of the computerized watermark embedding engine 110. One module, a computerized watermark integrating engine 425, is configured to receive a set of personal identifiers 410 and a set of publisher identifiers 420, which may be received from a non-transitory computer readable storage media 405 and 415, respectively. The computerized watermark integrating engine 425 is communicatively coupled to another module, the computerized embedding decision engine 440, which is configured to receive the ebook 435, which may be received from a non-transitory computer readable storage media 430, and information from the computerized watermark integrating engine 425. The computerized embedding decision engine 440 is communicatively coupled to yet another module, the computerized watermark generator 445, which creates the watermarked ebook 120. The watermarked ebook 120 may then be transmitted to a user device 210A-N. Still another module may be used to transmit the watermarked ebook 120. A person having ordinary skill in the art will appreciate that the exemplary embodiment seller server embedding engine 400 may include more, less, or different components and modules than the ones illustrated, which are shown merely as one example. Therefore, modifications, changes, and different configurations may be made without departing from the spirit and scope of this disclosure.

The computerized watermark integrating engine 425 produces an exemplary watermark 125 that may have one or more attributes. Typically, there is more than one attribute associated with the watermark 125 and the computerized watermark integrating engine 425 may combine the personal identifiers 410 and the publisher identifiers 420 into a single, human readable image. The computerized watermark integrating engine 425 may make decisions on the type of watermark 125 to produce based on the amount of information contained within the personal identifiers 410 and publisher identifiers 420. For example, if the book title comprises multiple words and the user email comprises over 35 characters, then the watermark integrating engine may choose a larger watermark 125 to maintain the information in a legible format. A person having ordinary skill in the art will appreciate that the exemplary computerized watermark integrating engine 425 may combine the information in virtually endless combinations depending on the attributes of the user or the ebook.

The computerized embedding decision engine 440 may receive the completed watermark 125 from the computerized watermark integrating engine 425 and receive the ebook 435. After surveying the content of the ebook 435, the computerized embedding decision engine 440 may determine an appropriate location to embed the watermark 125. The computerized embedding decision engine 440 may place the watermark 125 in one or more locations. If the computerized embedding decision engine 440 places more than one watermark 125, then the computerized embedding decision engine 440 may determine that the watermark 125 should be placed in the same location on designated pages, every page, or at randomly designated locations. A person having ordinary skill in the art will appreciate that the exemplary computerized embedding decision engine 440 may determine that the watermark 125 may be placed in virtually endless combinations depending on the attributes of the user or the ebook 435. Therefore, modifications, changes, and different configurations may be made without departing from the spirit and scope of this disclosure.

The computerized watermark generator 445 may receive the information from the computerized embedding decision engine 440. A typical function of the exemplary computerized watermark generator 445 is to embed the watermark 125 into the ebook 435 so that, when displayed, the text and/or pictures of the ebook 435 remain legible and the watermark 125 remains legible. The computerized watermark generator 445 may decide to alter the watermark 125, sacrificially in some instances, in order to maintain legibility of the content of the ebook 435. The computerized watermark generator 445 produces a watermarked ebook 120 and places it in a computer data cache that is ready display on a user device 210A-N.

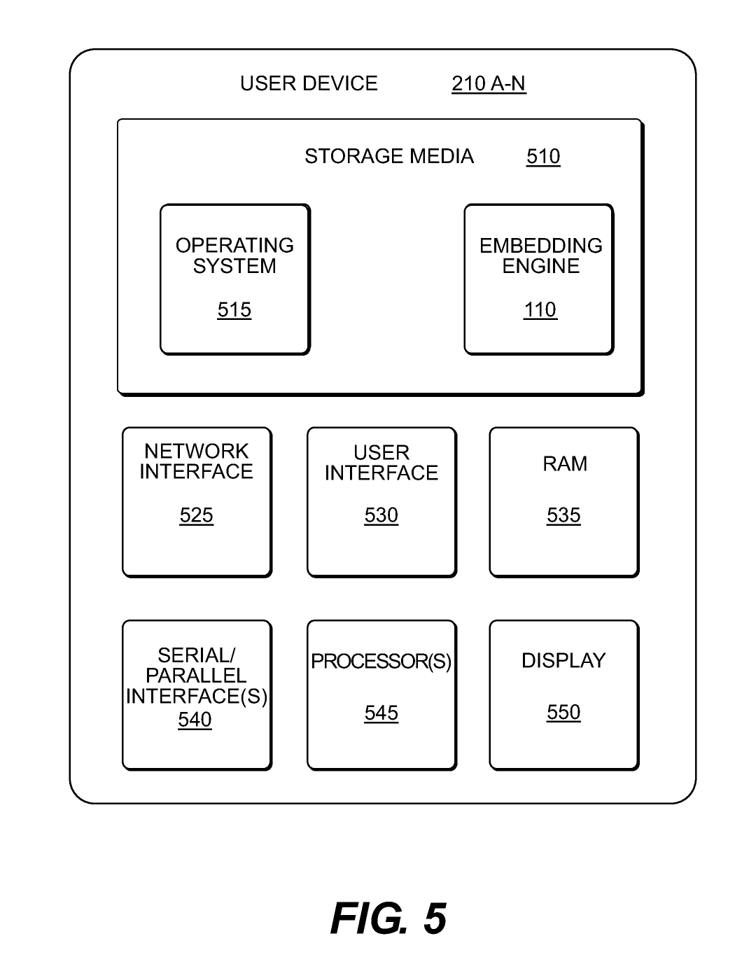

FIG. 5 shows an exemplary user device 210A-N whereby the exemplary embedding engine 110 and exemplary methods 100, 300 may be practiced. The exemplary user device 210A-N may include storage media 510 containing, among other software or firmware components or systems, an operating system 515 and an exemplary embedding engine 110. Storage media may be volatile or non-volatile. In addition, the user device 210A-N may comprise peripheral devices including, but not limited to a network interface adaptor 525, a user interface 530, random access memory 535, one or more serial or parallel interfaces 540, one or more processors 545, and a display 550. Examples of a network interface adaptor 525 include Wi-Fi, Bluetooth®, or cellular. Examples of a user interface 530 include a touch-screen, keypad, trackball, and mouse. A person having ordinary skill in the art will appreciate that the exemplary embodiment user device 210A-N may have more, less, or different components than the ones illustrated, which is shown merely as an example. Therefore, modifications, changes, and different configurations may be made without departing from the spirit and scope of this disclosure.

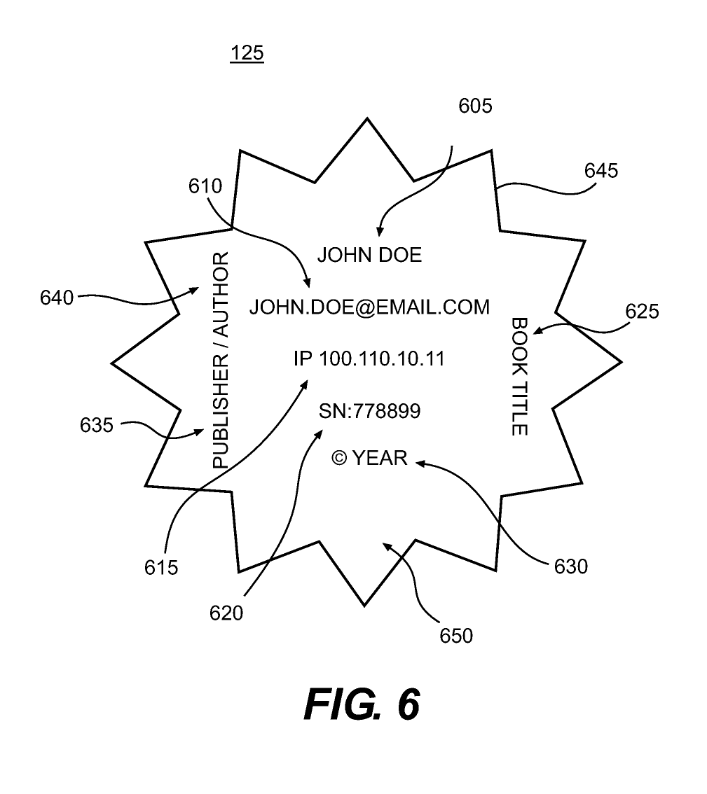

FIG. 6 shows an exemplary embodiment watermark 125 in greater detail. The watermark 125 may have personal identity information comprising a user name 605, a user email address 610, a user device IP address 615, and a serial number 620. The serial number 620 may be unique to a transaction between the seller and the user, but may also reference publisher information. In addition, the watermark 125 may have publisher information comprising a title of the ebook 625, a year in which the ebook was copyrighted 630, a publisher name 635, and an author name 640. Other features of the watermark may or may not include a symbol 645 surrounding the personal information and publisher information and a region 650 within the symbol with varying degrees or styles of shading. A person having ordinary skill in the art will appreciate that the exemplary embodiment watermark 125 may have more, less, or different features than the ones illustrated, which is shown merely as an example. Therefore, modifications, changes, and different configurations may be made without departing from the spirit and scope of this disclosure.

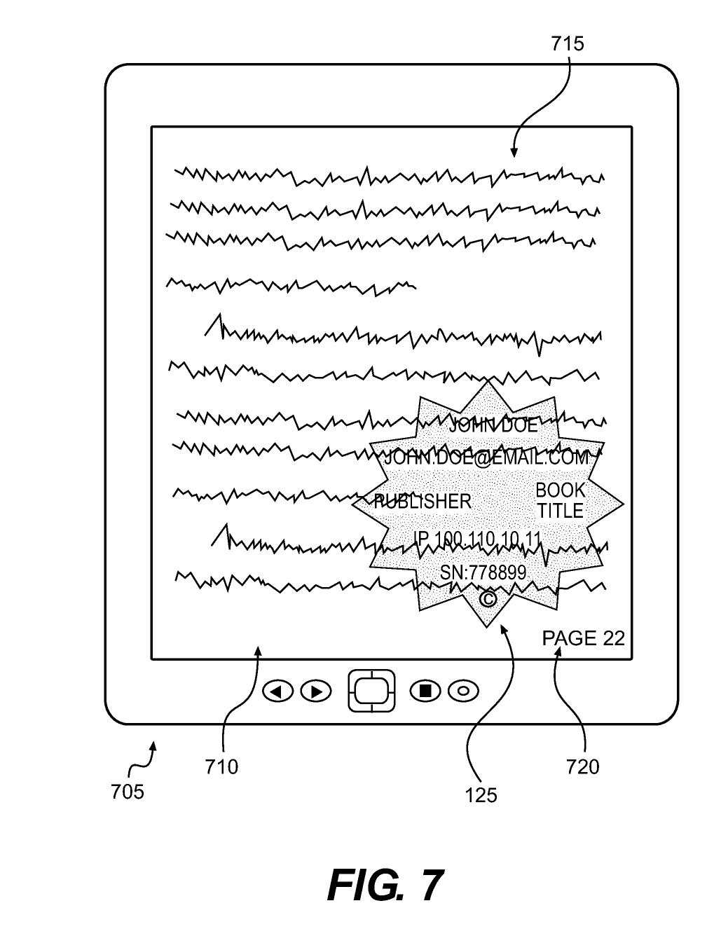

FIG. 7 shows an exemplary display 705 from an exemplary user device 210A-N with an exemplary embodiment watermark 125 displayed with the ebook content 715. The watermark 125 may reside anywhere within empty space 710 surrounding the ebook content 715, as determined by the watermark generator 445. Generally, the watermark 125 underlays the ebook content and certain portions of the watermark 125 may be obscured in favor of displaying the ebook content 715. A page number 720, or other ebook reference information, may or may not be included in a margin of the display.

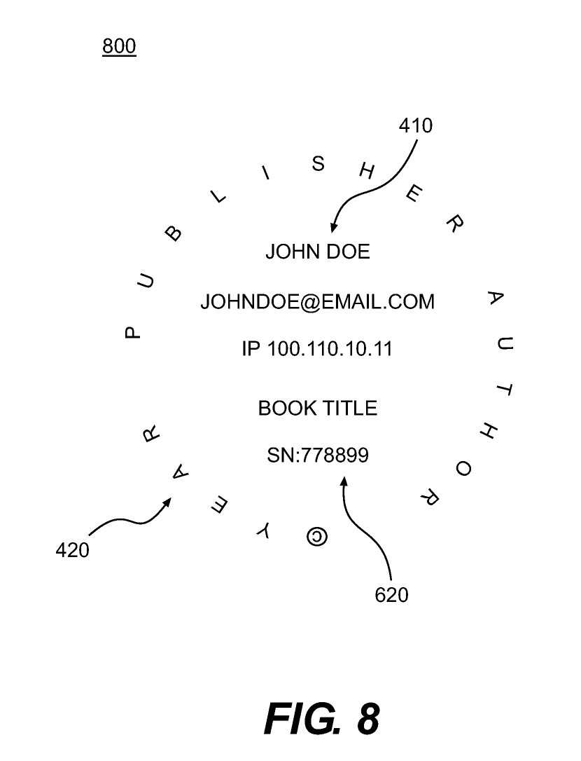

FIG. 8 shows another exemplary embodiment watermark 800 comprising the personal identity information 410, publisher information 420, and serial number 620 arranged in a different manner. Generally, the arrangement of information 410, 420 within the watermark 800, as determined by the watermark integrating engine 425, is designed to be difficult to remove once the watermark 125, 800 is embedded in the ebook 120.

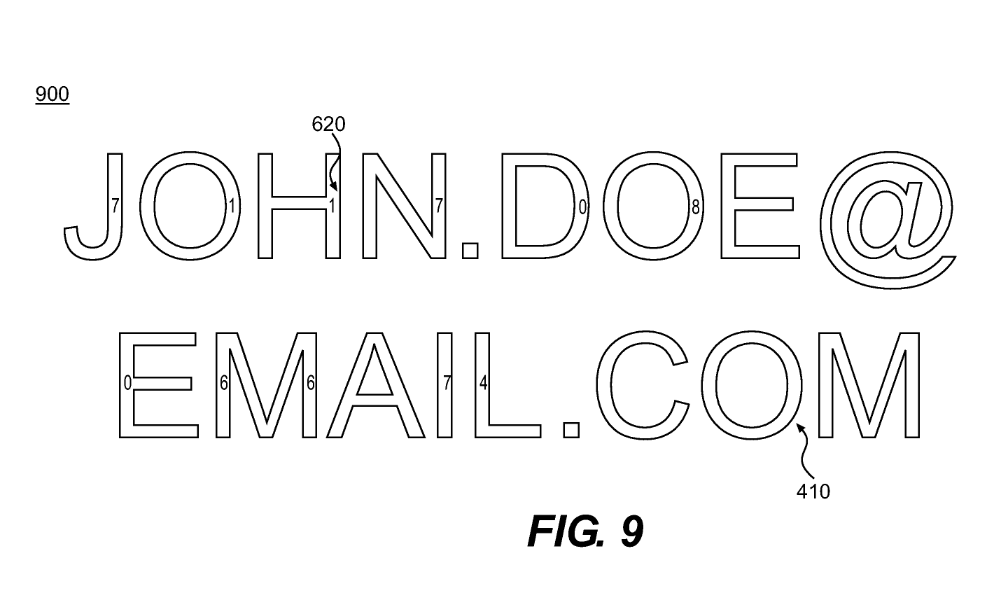

FIG. 9 shows still another exemplary embodiment watermark 900 comprising the personal identity information 410 and serial number 620 arranged in a different manner. In this embodiment, the serial number 620 is much smaller font than the personal identity information 410 so that it can be located within the constituent letters or numbers of the personal identity information 410.

Various methods and processes described above may be implemented via computer-operated instructions that are stored on non-transitory computer media, such as a hard-drive, ROM, RAM, USB, and so forth. And as such, can be devised to automatically and electronically (via software code) perform the various methods and processes described.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computerized method for deterring unauthorized distribution of an electronic book, the method comprising:
electronically receiving a request to purchase the electronic book;
electronically receiving a set of personal identifiers from a user;
electronically receiving a set of publisher identifiers from a publisher of the electronic book;
electronically embedding at least one identifier of the set of personal identifiers and at least one identifier of the set of publisher identifiers into the electronic book;
electronically storing the electronic book with the set of personal identifiers and the set of publisher identifiers to a computer memory, wherein the computer memory contains information of a unique transaction between the user and a seller;
electronically transmitting the electronic book to a user device; and
displaying the at least one embedded identifier when content of the electronic book is displayed on the user device, wherein the at least one embedded identifier is located on at least one page of the electronic book.

2. The method of claim 1, wherein the set of personal identifiers comprise an email address of the user.

3. The method of claim 1, wherein the set of publisher identifiers comprise a serial number of the electronic book.

4. The method of claim 1, wherein the at least one embedded identifier is visibly located on at least one page in the electronic book.

5. The method of claim 1, wherein the at least one embedded identifier is invisibly located on at least one page in the electronic book.

6. The method of claim 1, wherein the at least one embedded identifier is displayed randomly on at least one page in the electronic book.

7. The method of claim 1, wherein the at least one identifier of the set of personal identifiers is embedded into the set of publisher identifiers.

8. The method of claim 1, wherein the computer memory contains a single inseparable data cache comprising the electronic book, the set of personal identifiers, and the set of publisher identifiers.

9. A watermark embedding system for an electronic book, comprising:
a computerized watermark embedding engine;
a computerized watermark generator in the computerized watermark embedding engine, the computerized watermark generator operating to produce a watermark for the electronic book, wherein the watermark includes at least one personal identity information about a first user of the electronic book and at least one publisher information about the electronic book;
a computerized watermark integrating engine in the computerized watermark embedding engine, the computerized watermark integrating engine operating to combine the personal identity information and the publisher information into a single watermark; and
a computerized watermark decision engine in the computerized watermark embedding engine, the computerized watermark decision engine operating to insert the watermark into the electronic book, wherein if the electronic book contains more than one page, then the watermark decision engine decides which pages to receive the watermark, wherein the watermark decision engine is further configured to decide a location on the page in which to place the watermark.

10. The embedding system of claim 9, wherein the computerized watermark embedding engine is stored on a on a seller server computer memory.

11. The embedding system of claim 9, wherein the computerized watermark embedding engine is stored on a first user device computer memory.

12. The embedding system of claim 9, wherein the computerized watermark embedding engine is indivisible from the electronic book.

13. The embedding system of claim 9, wherein the computerized watermark generator places the watermark at random locations in the electronic book to prevent easy removal.

14. The embedding system of claim 9, wherein the computerized watermark generator places the watermark that becomes visible only when the electronic book is transmitted to a second user.

15. An unauthorized copying-deterrent system for an electronic book, the system comprising:
a web-based system;
a copying-deterrent module in the web-based system, the module having a plurality of computer readable instructions that implements a copying-deterrent method;
a module having a plurality of computer readable instructions that operate to receive a request from a first user to purchase the electronic book via the web-based system;
a module having a plurality of computer readable instructions that operate to receive a set of personal identifiers from the first user;
a module having a plurality of computer readable instructions that operate to receive a set of publisher identifiers from a publisher of the electronic book;
a module having a plurality of computer readable instructions that operate to embed the set of personal identifiers and the set of publisher identifiers into the electronic book;
a module having a plurality of computer readable instructions that operate to store the electronic book with the set of personal identifiers and the set of publisher identifiers to a computer memory, wherein the computer memory contains information of the first user and the publisher;
a module having a plurality of computer readable instructions that operate to transmit the electronic book to a first user device; and
a module having a plurality of computer readable instructions that operate to display the set of personal identifiers and the set of publisher identifiers when the electronic book is displayed on the first user device, wherein the set of personal identifiers and the set of publisher identifiers are located on at least one page of the electronic book.

16. The unauthorized copying-deterrent system of claim 15, wherein the at least one identifier of the set of personal identifiers is embedded into the set of publisher identifiers.

17. The unauthorized copying-deterrent system of claim 15, wherein the set of personal identifiers and the set of publisher identifiers comprise a single image when the electronic book is displayed on the first user device.

18. The unauthorized copying-deterrent system of claim 15, wherein the set of personal identifiers and the set of publisher identifiers become visible only when the electronic book is electronically transmitted to a second user device.

19. The unauthorized copying-deterrent system of claim 15, wherein the set of personal identifiers comprise an email address of the user.

20. The unauthorized copying-deterrent system of claim 15, wherein the set of publisher identifiers comprise a serial number of the electronic book.
